(19) United States
(12) Patent Application Publication
(10) Pub. No.: US 2010/0038384 A1
(43) Pub. Date: Feb. 18, 2010

(54) Fluid Dispensing

(76) Inventors: Mark Wallace, South Staffordshire (GB); Ryan John Chessar, Warwick (GB); Clive Justin Edmunds, Norfolk (GB); Jeremy Carey, Huntingdon (GB); Michael Cameron Bainton, Kineton (GB)

Correspondence Address: PYLE & PIONTEK LLC, 221 N. LASALLE STREET, SUITE 1207, CHICAGO, IL, 60601, US

(21) Appl. No.: 11/886,355

(22) PCT Filed: Mar. 16, 2006
(86) PCT No.: PCT/GB2006/000927

§ 371 Date: Dec. 17, 2008

(30) Foreign Application Priority Data
Mar. 16, 2005 (GB) 0505343.4
Feb. 28, 2006 (GB) 0603935.8

(51) Int. Cl. B67D 7/58; B65D 83/00; B65B 1/04

(52) U.S. Cl. 222/372; 222/325; 141/2; 222/383.3

(57) ABSTRACT

A fluid dosing cartridge (110) comprising a fluid reservoir (112), a delivery conduit (114) with an output nozzle (22), a nozzle socket (24), a pump chamber (42) and plunger (44), and a check valve assembly (118). The check valve assembly (118) comprises a valve housing (26), defining a valve chamber (32), and first (34), second (36) and third (38) valve ports, and first and second check valves (28, 30). Each check valve (28, 30) comprises a stainless steel ball (46) resiliently biased under the action of a spring (50) and a valve seat (48). The valve seat (48) comprises a body member (52) and a circular wall member (56) defining a valve aperture (54). The valve seat (48) is formed from an ethylene based octene polymer material to give the valve seat (48) a degree of material compliance, such that the sealing section (56a) of the wall member (56) deforms under contact with the resiliently biased stainless steel ball (46), to thereby improve the seal closure between the valve seat (48) and the stainless steel ball (46).

The present invention relates to disposable dispensing cartridges for flowable products and to fluid dosing cartridges.

Traditionally, flowable products consumed by a process or a machine have been supplied in bulk and dispensed by various means when needed. While this is satisfactory for many applications there are a growing number of markets where there is a trend towards reducing the necessary cleaning of machinery by incorporating as many of the product contact parts as possible into a single consumable which is simply removed and disposed of at the end of its use and replaced with another consumable.

In markets where hygiene is of importance or the required “down time” of cleaning machinery introduce a financial burden and where a product needs to be dispensed then product cartridges can be used comprising a reservoir which contains the product and some form of pumping means for dispensing the product. A number of pumping means which operate on the principle of drawing a volume of product in, and then expelling it, frequently utilise check valves to prevent back flow of the fluid in the system.

Historically the product cartridges are assembled and filled at the same site this is a good solution for very high volume production where the quantities involved can justify the cost of assembly at the point of manufacture of the product. This can be advantageous from a logistical perspective as unfilled cartridges are not required to be shipped around. This is typically used for high volume products where no dispensing is required—for example a beverage producer will often manufacture and fill their own product containers on site. However where lower volumes cannot justify a dedicated site and when the product the cartridge will contain is not manufactured close to the preferred manufacturing site of the cartridge, there is a need to manufacture cartridges at one site and fill them in another to enable the producers to take advantage of the benefits of low cost manufacturing locations. In addition if the product is perishable, for example a food ingredient, then it is advantageous to fill the cartridge in the locality of the point of dispense for freshness yet still be able to take advantage of lower cost overseas manufacturing. Also, if there are special manufacturing requirements (for example a clean room manufacturing process or similar) it may not be economic to set up this specialist facility for one filling site.

For some designs of cartridge/pump combinations this does not present a problem and the cartridge can simply be back filled from the outlet as, for example, in the case of a peristaltic type pump comprising some peristaltic tube attached to the reservoir which is driven externally. In this case the reservoir can simply be filled by pumping fluid into it via the peristaltic tube; however without further sealing there is no means of retaining the product in the reservoir. Where the cartridge is of the type described above which incorporates check valves it is not possible to backfill the cartridge as the check valves prevent flow of product in that direction.

Fluid dosing cartridges are used in a wide variety of applications where small amounts of fluid substances are required to be dosed into a base or carrier fluid. One such application is in the food and beverage market, both in vended products and in packaging of food products, where a flavour concentrate needs to be added to a base fluid. Flavour concentrates (as opposed to flavour syrups which include sugar, salts etc.) consist of highly concentrated (about 1:1000 to 1:10,000 dilution ratio) collections of flavoursome organic molecules provided in an organic solvent base. Flavour concentrates contain fairly aggressive chemicals, mainly short chain hydrocarbons such as citrus essential oils, terpenes and various aldehydes.

The components of known fluid dosing cartridges are generally fabricated from polymers. This presents a problem when dosing flavour concentrates because since polymers are also made of organic materials there is a tendency for the polymers to absorb short chain hydrocarbons from the flavour concentrate (a process known as scalping). In addition, there is a tendency for any plasticisers present within polymers to be leached out into the flavour, and both leaching and scalping can cause the taste profile of the flavour to be modified. Leaching and scalping occur heavily when using looser polymers and are especially prevalent when using elastomers, some of which can swell by as much as 50% due to scalping. Although these effects can be minimised by using heavily cross linked and denser polymers, this is not always practicable.

It is the purpose of the present invention to mitigate some of the above problems by providing a dispensing cartridge for a flowable product which can easily be manufactured at one site and filled at another.

According to a first aspect of the present invention there is provided a disposable dispensing cartridge for a flowable product comprising a reservoir for storing the product, a pump means having a pump chamber and operative to withdraw said product from the reservoir into the pump chamber and to expel liquid from the chamber; a first passageway interconnecting the reservoir and the pump chamber; a second passageway interconnecting the pump chamber and a outlet from the chamber; a valve means operable, in use, by differential fluid pressure, to open the first passageway and close the second passageway during a liquid withdrawal step, and to close the first passageway and open the second passageway during the expelling step, characterised in that the cartridge further comprises a means to maintain the valve means in a position in which both passageways are simultaneously open and interconnected thereby enabling the reservoir to be filled via the outlet.

Preferably the valve means comprises a first valve means associated with the first passageway and a second valve means associated with the second passageway.

Preferably the first and second valve means comprise a pair of check valves and the cartridge comprises a means to hold the check valves open allowing back flow past them enabling the reservoir to be filled and, preferably, once the cartridge has been filled, the check valves can assume their normal working position preventing flow in the direction from the outlet to the reservoir so that activation of the pump draws product from the reservoir and expels it out of the outlet.

Preferably once the check valves have assumed their normal position, the means for holding them open cannot be reemployed, thus preventing the used cartridge from being refilled.

Preferably the pump is a piston pump comprising a piston in a chamber and the piston carries the means that holds the check valves in their open position to allow for back filling of the reservoir. Preferably that means is a thin finger like extension protruding from its forward end.

Preferably each check valve comprises a spring loaded closure element closing against a valve seat and the means on the piston displaces the closures away from their seats, against the action of the springs, thereby maintaining them in their open positions.

Preferably the check valves are substantially at 90 degrees to one another and the means displaces the closure of one check valve, along the axis of the piston's travel within the chamber and preferably maintains the other check valves in its open position by being located between the closure and the valve seat.

Preferably there is an elongate conduit between the second check valve and the cartridge outlet and preferably that conduit is flexible, allowing the product from the cartridge to be dispensed to a point in the vicinity of, but not immediately adjacent to, the cartridge. Preferably there is a third check valve at the end of the conduit to prevent product dripping therefrom, but as will be apparent, this third check valve would need to be fitted after the cartridge had been filled.

Preferably the cartridge further comprises data storage means, preferably electronic, capable of storing data pertaining to the flowable product within the cartridge.

According to a second aspect of the invention there is provided a method of filling a disposable dispensing cartridge with a flowable product comprising the steps of: assembling a disposable dispensing cartridge comprising a reservoir for storing the product, a pump, a first check valve between the reservoir and the pump, a second check valve between the pump and an outlet of the cartridge, the arrangement being such that the first and second check valves are maintained in an open position allowing backflow past them; presenting the cartridge outlet to a filling means, pumping the flowable product from the filling means into the reservoir via the open check valves; and, once the reservoir is full, causing or allowing the check valves to assume their normal position preventing flow in the direction from the outlet to the reservoir.

Preferably the method of filling the cartridge further includes the intermediate step between presenting the cartridge outlet to a filling means and pumping the flowable product from the filling means into the reservoir of at least partially evacuating the reservoir of air (or any other gas) by applying, by the filling machine, a partial vacuum to the outlet of the cartridge.

Preferably the method of filling a disposable dispensing cartridge with a flowable product comprises the steps of assembling the cartridge such that means associated with the piston of a piston pump holds inlet and outlet check valves of a pump chamber in an open position when the piston is in its forward position, presenting the cartridge outlet to a filling means, pumping a flowable product from the filling means into the reservoir via the open check valves and, once the reservoir is full, withdrawing the piston into the piston chamber sufficiently that the check valves are released and assume their activated position preventing flow from the outlet into the pump chamber and from the pump chamber into the reservoir.

Preferably once the reservoir is full the piston is withdrawn further into the pump chamber to draw fluid from the reservoir into the pump chamber thereby priming the pump ready for dispense.

Normally, the stages of assembling the cartridge and filling the cartridge will be conducted at two separate locations, the assembled cartridges being transported empty to the filling location with the check valves held in their open position.

Preferably the method further comprises the step of separating the cartridge outlet from the filling means and attaching a check valve to the end of the outlet conduit.

Where the cartridge comprises data storage means capable of storing data pertaining to the flowable product within the cartridge and the method of filling the cartridge further comprising the step of writing to the electronic data storage means at least the type of product with which the cartridge has been filled and preferably also other data pertinent to the flowable products, for example its concentration or shelf life.

According to a third aspect of the present invention there is provided a fluid dosing cartridge comprising:
a fluid reservoir;
a delivery conduit;
a positive displacement pump; and
a check valve assembly comprising a valve housing and a check valve,
the valve housing defining a valve chamber and first, second and third valve ports, the first valve port being coupled to the fluid reservoir, the second valve port being coupled to the positive displacement pump, and the third valve port being coupled to the delivery conduit, and
the check valve being provided generally within the first valve port, to open and close the first valve port, and the check valve comprising a resiliently biased closure member and a valve seat of an ethylene based octene polymer material, the valve seat being of a complementary shape to part of the surface of the closure member, and being compliant under contact with the closure member to thereby improve the seal closure between the valve seat and the closure member.

The check valve assembly preferably further comprises a second check valve provided generally within the third valve port, to open and close the third valve port, the second check valve comprising a second resiliently biased closure member and a second valve seat of an ethylene based octane polymer material, the second valve seat being of a complementary shape to part of the surface of the second closure member, and being compliant under contact with the second closure member to thereby improve the seal closure between the second valve seat and the second closure member.

The fluid dosing cartridge preferably further comprises an output nozzle provided at the distal end of the delivery conduit, the output nozzle comprising a nozzle housing defining a fluid outlet and a third check valve provided generally within the fluid outlet, to open and close the fluid outlet, the third check valve comprising a third resiliently biased closure member and a third valve seat of an ethylene based octene polymer material, the third valve seat being of a complementary shape to part of the surface of the third closure member, and being compliant under contact with the third closure member to thereby improve the seal closure between the third valve seat and the third closure member.

The positive displacement pump preferably comprises a pump chamber and plunger which seals with the pump chamber, one end of the pump chamber being coupled to the second valve port. The wall of the pump chamber is preferably flexible and the plunger is rigid such that the pump chamber wall expands slightly outwards around the plunger as is moves through the pump chamber, thereby maintaining the seal between the pump chamber and the plunger. In an alternative arrangement the plunger may have a flexible vane around its perimeter which deflects against the wall of the pump chamber, thereby maintaining the seal between the pump chamber and the plunger.

The or each resiliently biased closure member is preferably an at least part spherical closure member, and most preferably comprises a stainless steel ball. The or each closure member is preferably resiliently biased under the action of a resilient member, most preferably a spring. The resilient member preferably exerts a biasing force on the closure member which is sufficiently low enough that the biasing force can be overcome by the creation of a vacuum or a fluid flow by appropriate movement of the plunger within the pump chamber and that the vacuum required to overcome the resilient force is low enough that it does not exceed the vapour pressure of the liquid being pumped. By maintaining the pressure in the liquid below its vapour pressure, cavitation is prevented the resultant bubbles of which would alter the volume of fluid dispensed in the displacement action of the plunger. Preferably the spring force is less than 1 Newton metre.

The or each valve seat preferably comprises a circular wall member enclosing a valve aperture, a section of the internal surface of the circular wall member forming the sealing surface of the valve seat. The section of the circular wall member against which the closure member makes sealing contact most preferably has an angled profile. Preferably the included angle of the said section of the circular wall member is sufficiently acute that the material of the circular wall member has the requisite compliance for, and that the closure member is guided into, sealing contact between the closure member and the circular wall member, but is not sufficiently acute that the closure member can become wedged therein. Preferably the included angle of at least the said section of the circular wall member is in the range of 30 to 50 degrees, more preferably the included angle is 40 degrees. Preferably, one or more sections of the circular wall member are thinner than the rest of the circular wall member, to provide additional compliance of the valve seat under contact with the resiliently biased closure member.

Due to the necessary tolerances to achieve a reliable seal between the closure member and the valve seat the valve seat is preferably an independent part which is inserted into a valve assembly.

The positive displacement pump preferably further comprises a nose member extending outwardly from the distal end of the plunger towards the one end of the pump chamber, the nose member being of a length and size suitable to be received through the second and third valve ports to open the second check valve, and to hold the first check valve open, to thereby allow fluid to be delivered through the delivery conduit to the fluid reservoir prior to the said third check valve in said outlet nozzle being connected to the distal end of said conduit.

According to a fourth aspect of the invention there is provided a fluid dosing cartridge comprising:
a cartridge housing;
a fluid reservoir received within the cartridge housing;
a delivery conduit having an output nozzle at its distal end;
a positive displacement pump;
a check valve assembly arranged to couple the fluid reservoir to the positive displacement pump, and to couple the positive displacement pump to the delivery conduit; and
a nozzle socket provided on the cartridge housing, the socket being of a complementary size and shape to the nozzle to securely and releasably receive the nozzle therein.

The nozzle socket is preferably made of a sterilizable material. A sterilized output nozzle can therefore be received within a sterilized nozzle socket, to maintain it in a sterile condition.

The nozzle socket is preferably provided at a location on the cartridge that is higher than the end of the delivery conduit coupled to the check valve assembly. This prevents siphoning of fluid through the delivery conduit when the cartridge is not in use.

The nozzle socket is preferably provided at a location on the cartridge that is horizontally displaced from the end of the delivery conduit that is coupled to the check valve assembly. Preferably, the distance from the end of the delivery conduit that is coupled to the check valve assembly to the nozzle socket is less than the length of the delivery conduit and the nozzle, and the end of the delivery conduit that is coupled to the check valve assembly is sufficiently spaced from the nozzle socket such that the delivery conduit curves around the cartridge but does not crease when bent to locate the nozzle in the nozzle socket.

According to a fifth aspect of the invention there is provided a fluid dosing cartridge comprising:
a cartridge housing;
a fluid reservoir received within the cartridge housing and comprising a collapsible bag having a spout provided at one end, the longitudinal axis of the spout being rotationally offset from the longitudinal axis of the cartridge housing, such that as the bag is collapsed it adopts a longitudinally curved shape;
a delivery conduit;
a positive displacement pump; and
a check valve assembly coupling the spout of the fluid reservoir to the positive displacement pump, and the positive displacement pump to the delivery conduit.

By causing the bag to collapse into a longitudinally curved shape, the longitudinal extension of the bag as it collapses is accommodated within the cartridge housing, ensuring that the bag collapses and empties fully and without forming any occluded areas in which fluid would otherwise be trapped.

The longitudinal axis of the spout is preferably rotationally offset from the longitudinal axis of the cartridge housing by approximately 10-30 degrees.

The spout is preferably provided with mechanical coupling means for coupling to complementary mechanical coupling means provided on the check valve assembly. Preferably, a first part of a threaded mechanical coupler is provided on the spout and a second part of a threaded mechanical coupler is provided on the check valve assembly, most preferably at the distal end of a connecting conduit extending outwardly from the check valve assembly to the spout.

The threaded mechanical coupler preferably has a quarter turn thread. The thread of the threaded mechanical coupler is preferably orientated such that the spout is turned in the direction of its rotational offset to close the threaded mechanical coupler. This ensures that any additional torque applied to the threaded mechanical coupler as the bag collapses causes the coupler to further tighten.

The spout is preferably provided towards the bottom of the collapsible bag. This helps to avoid any fluid being retained in the bag as it is emptied.

Embodiments of the invention will now be described in detail, by way of example only, with reference to the accompanying drawings, in which:

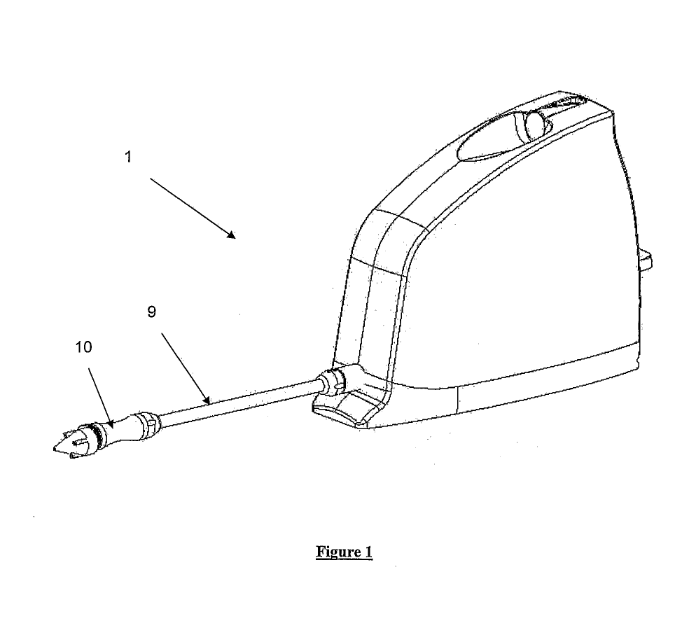

FIG. 1 is a perspective view of a dispensing cartridge according to a first embodiment of the invention;

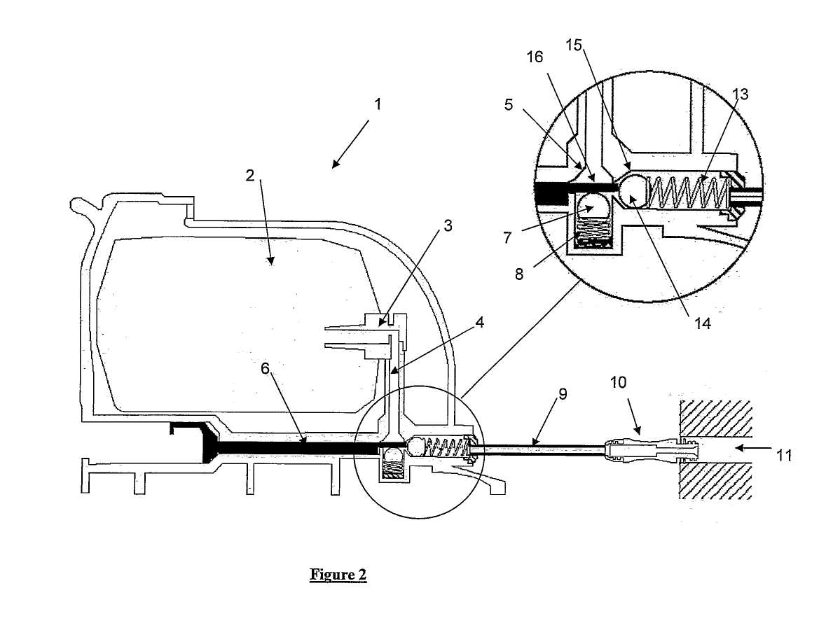

FIG. 2 is a sectional side view of a dispensing cartridge according to the first embodiment of the invention with an enlarged detail of its check valves in their open position prior to filling;

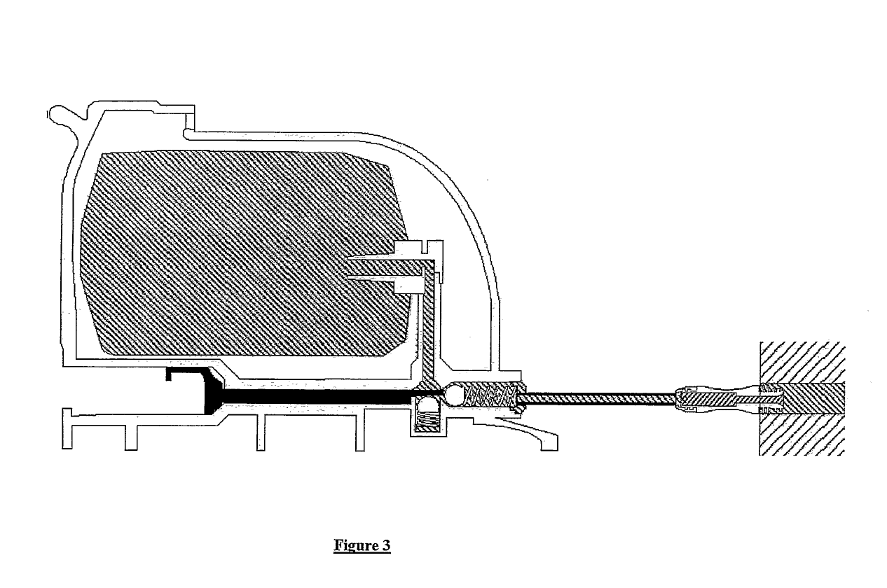

FIG. 3 is a sectional side view of a dispensing cartridge according to the first embodiment of the invention part way through the filling process;

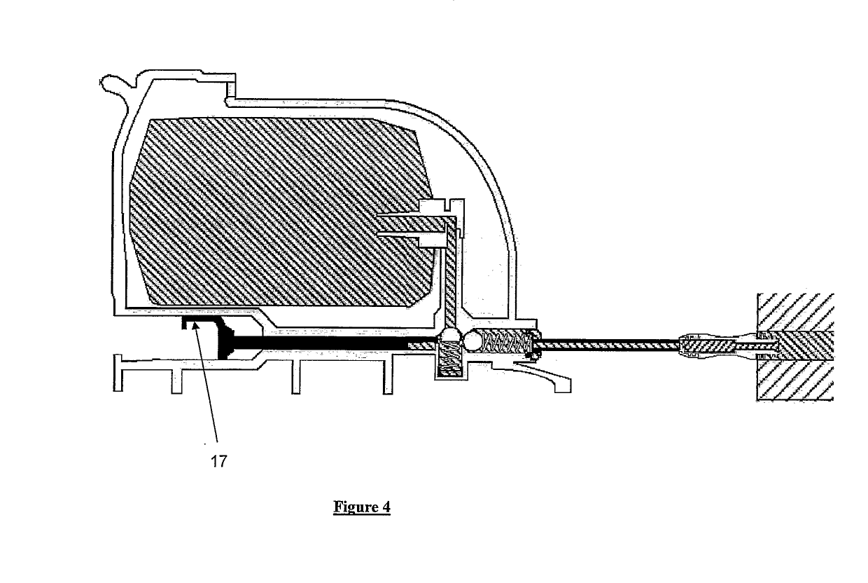

FIG. 4 is a sectional view of a dispensing cartridge according to the first embodiment of the invention with the piston partially withdrawn and its check valves in their closed position after filling;

FIG. 5 is a sectional view of a dispensing cartridge according to the first embodiment of the invention with its check valves in their closed position, a check valve added to the outlet, and the piston fully withdrawn and the chamber primed;

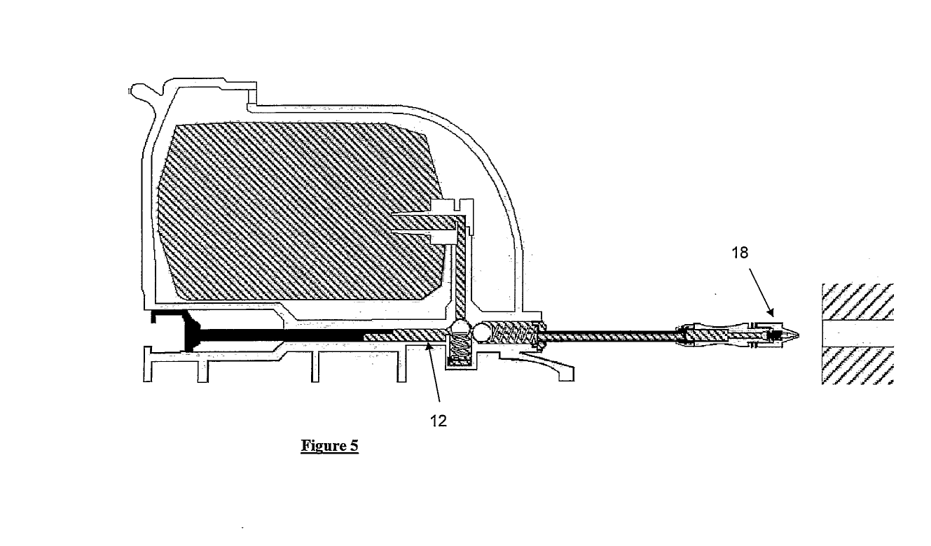

FIG. 6 is a diagrammatic representation of a fluid dosing cartridge according to a second embodiment of the invention;

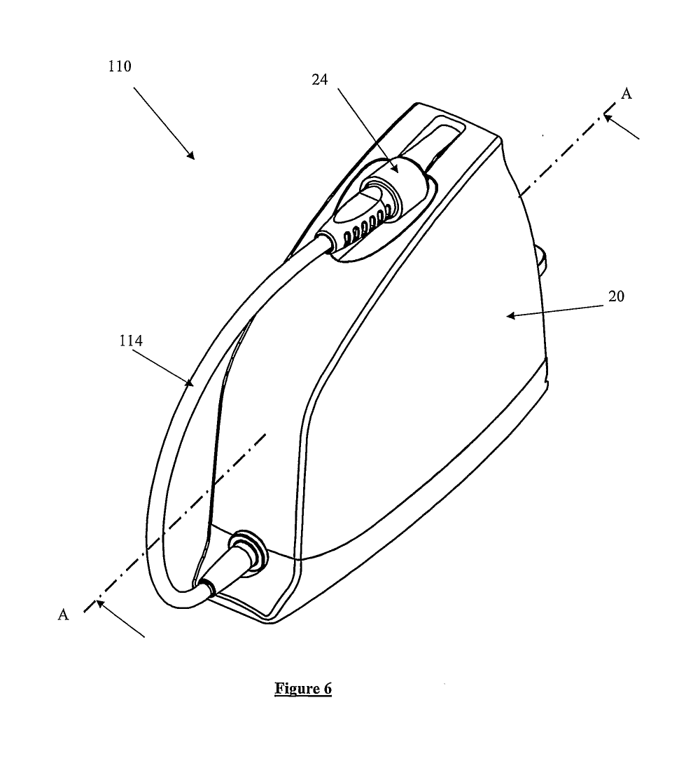

FIG. 7 is a diagrammatic cross-sectional view along line A-A of FIG. 1;

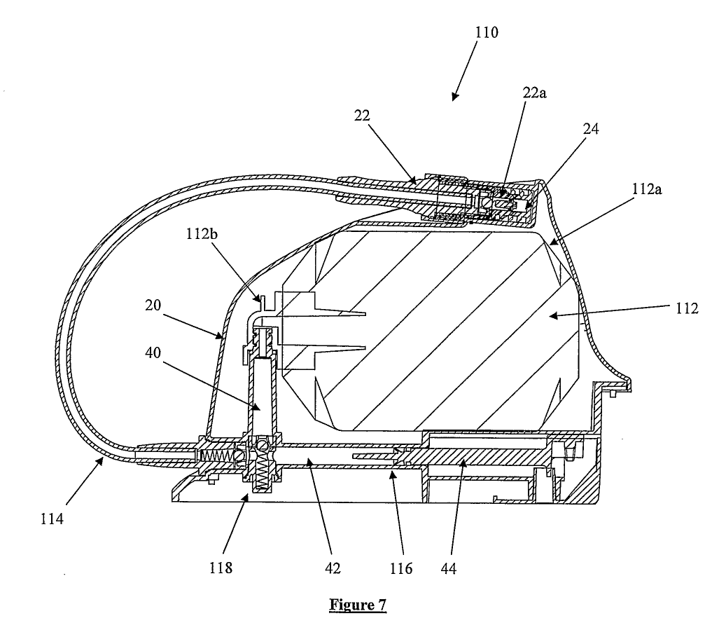

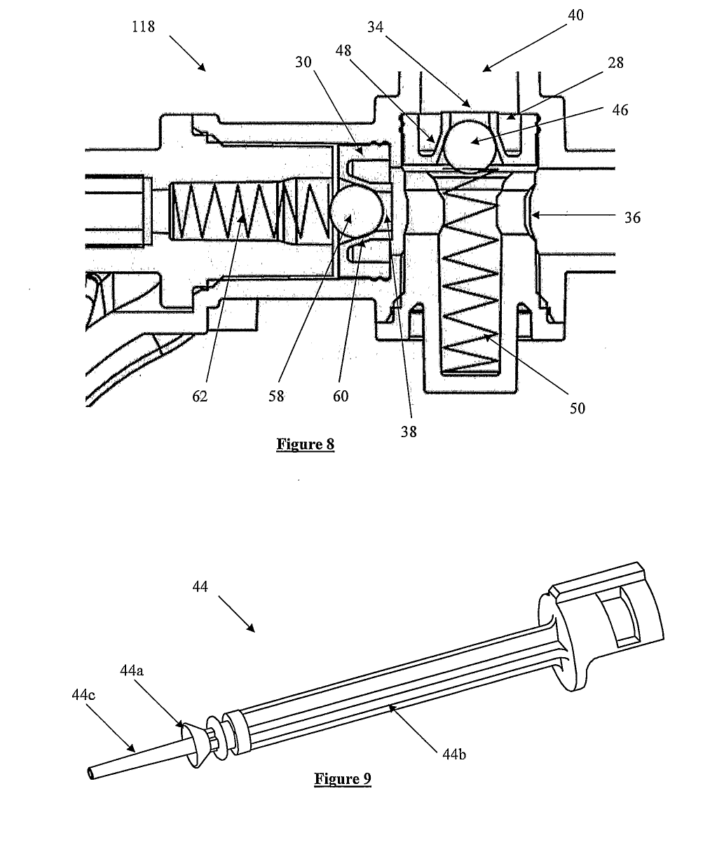

FIG. 8 is an enlarged diagrammatic cross-sectional view of the check valve assembly of FIG. 2;

FIG. 9 is a diagrammatic representation of the plunger of FIG. 7;

FIG. 10 is an enlarged diagrammatic cross-sectional view of one of the valve seats and closure members of the check valve assembly of FIG. 8;

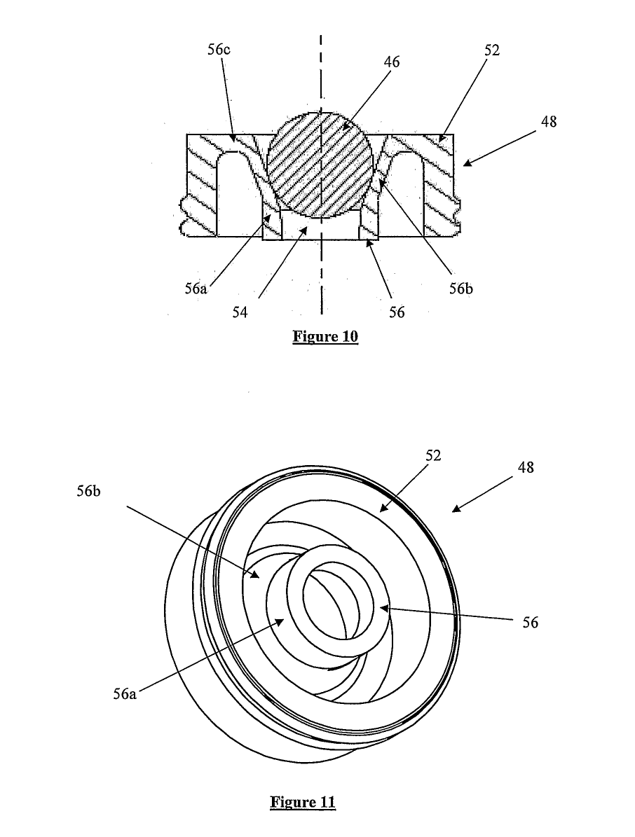

FIG. 11 is a diagrammatic representation of the valve seat of FIG. 10;

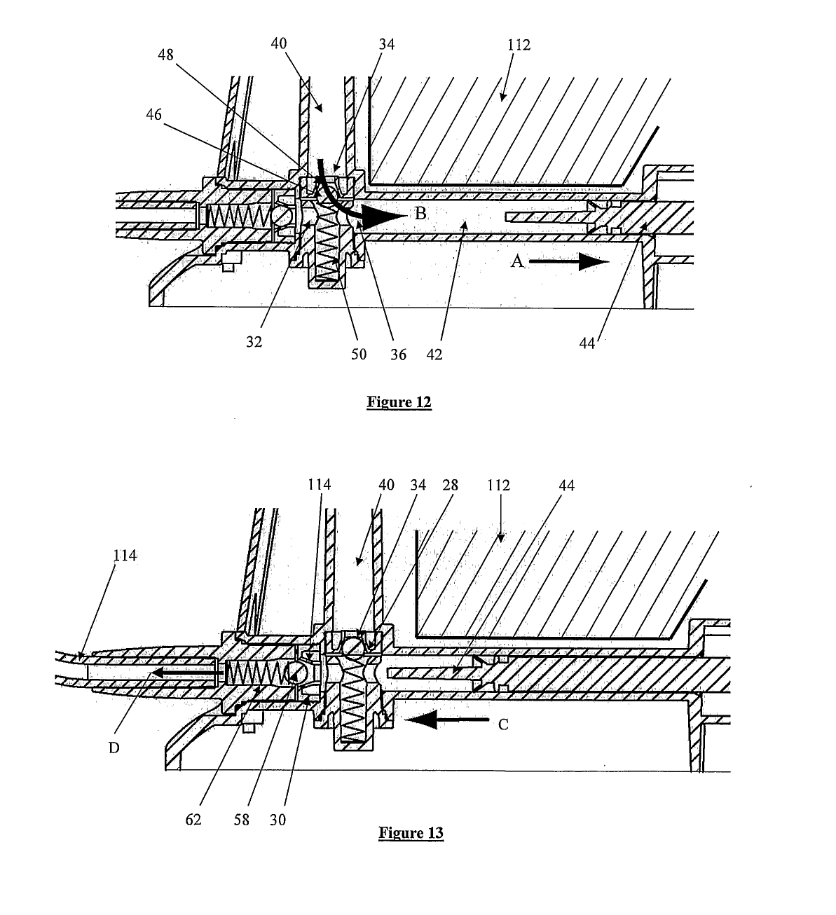

FIG. 12 is a part-view of FIG. 7, showing how fluid is drawn from the fluid reservoir into the pump chamber;

FIG. 13 is a part-view of FIG. 7, showing how fluid is expelled from the pump chamber and into the delivery conduit;

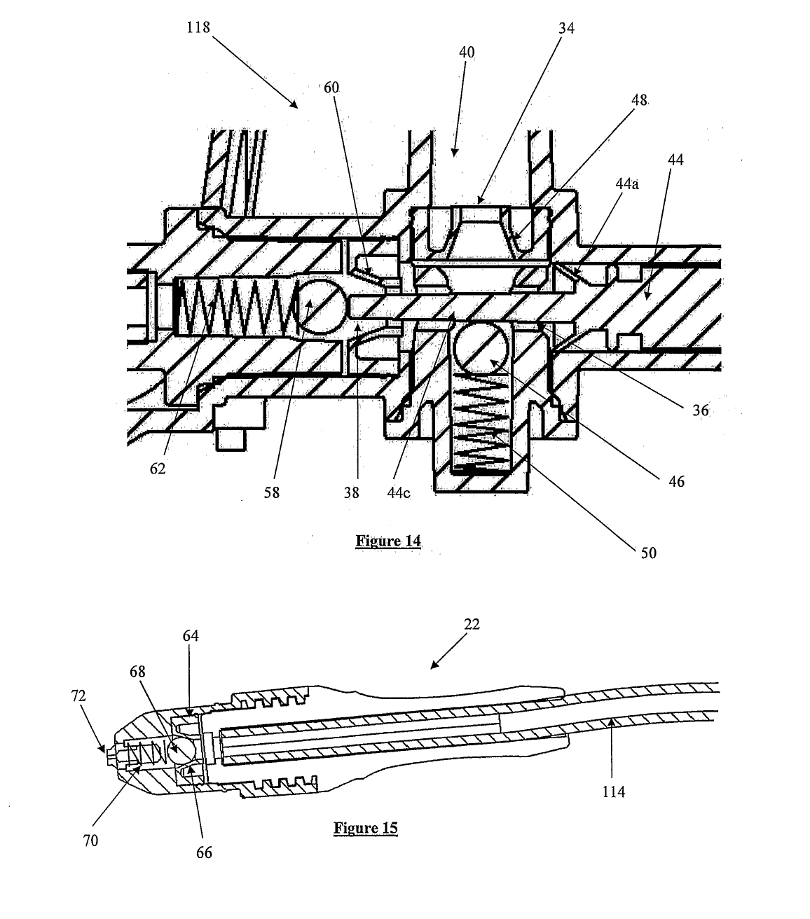

FIG. 14 is an enlarged diagrammatic cross-sectional view of the check valve assembly of FIG. 7 showing the nose of the plunger located through the check valve assembly;

FIG. 15 is a diagrammatic representation of the output nozzle of FIG. 7;

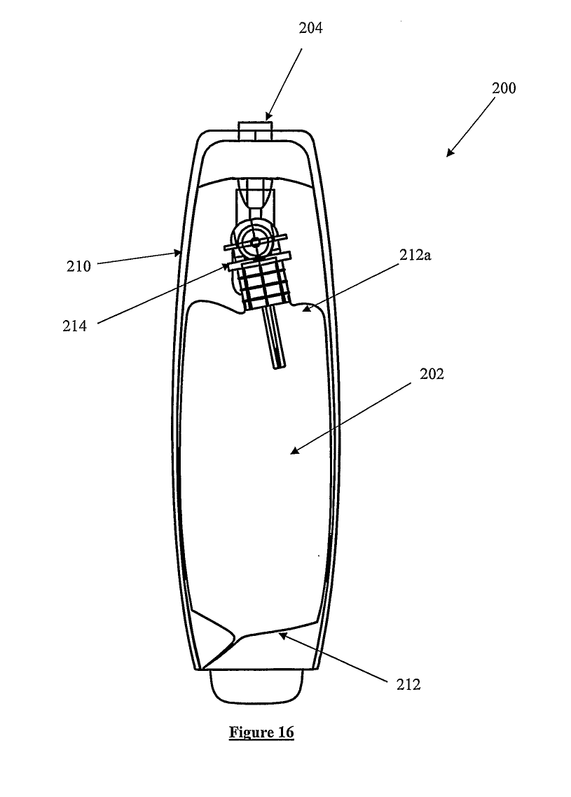

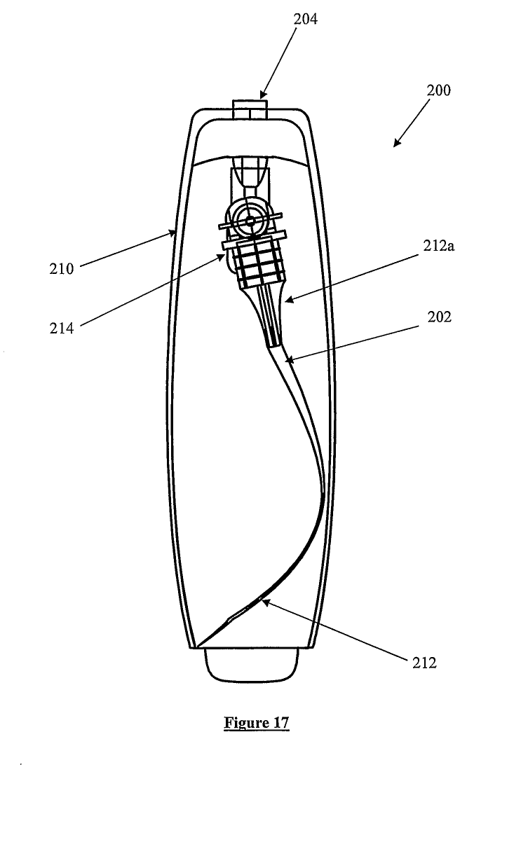

FIG. 16 is a diagrammatic sectional plan view of a fluid dosing cartridge according to a third embodiment of the invention, showing the collapsible bag in its full condition;

FIG. 17 shows the fluid dosing cartridge of FIG. 16 with the collapsible bag in its collapsed condition;

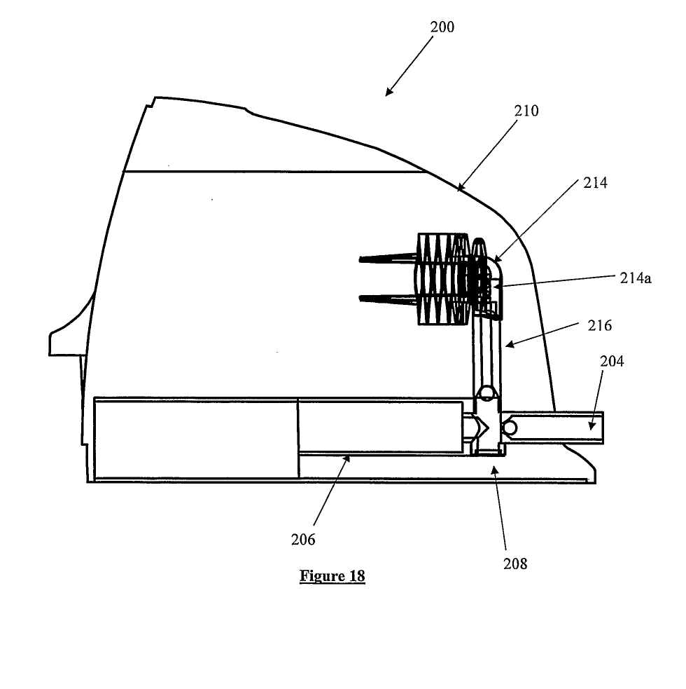

FIG. 18 a part sectional diagrammatic side view of the fluid dosing cartridge of FIG. 16 without the collapsible bag; and

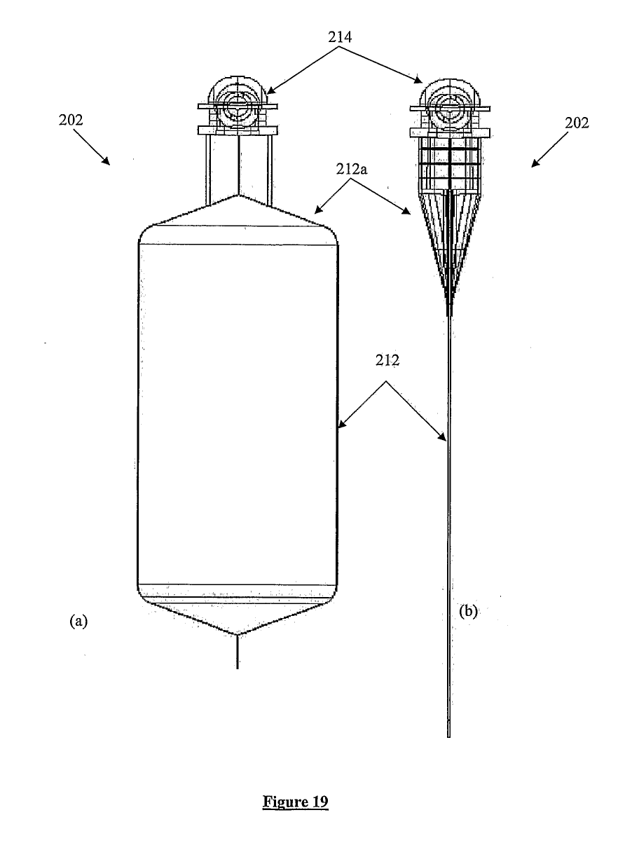

FIG. 19 shows diagrammatic plan views of the fluid reservoir (a) with the bag in its full condition and (b) with the bag in its collapsed condition.

FIGS. 1 to 5 all illustrate the same component and the numbers referred to in reference to a particular Figure also refer to the identical parts in the other Figures. For clarity, numbers have not been duplicated on each Figure. Referring to FIG. 1, an assembled dispensing cartridge 1 is shown which is ready to be filled. The cartridge 1 contains a reservoir 2 which is made of a flexible film, ideally a polymer film heat welded around its seams to form a bag. The reservoir may be a simple construction of two sheets seam welded around their edge to form a “balloon bag” or may comprise a number of panels welded around their edges to enclose a volume; preferably the panels are arranged that when empty they collapse in a controlled manner to substantially evacuate the entire content of the bag. Leading out of the reservoir 2 is a spout 3 with a passageway 4 leading therefrom. The passageway 4 terminates in a seating area 5 against which, when the piston 6 is withdrawn, a ball 7 is forced by spring 8 in sealing engagement preventing flow into the reservoir 2 via the passageway 4, the seating area 5, ball 7 and spring 8 forming a check valve. Extending from the cartridge 1 is a flexible conduit 9 which terminates in a coupling 10 which defines the cartridge outlet and which, during filling, is coupled to an outlet 11 of a filling machine. Between the conduit 9 and the pump chamber (12, FIG. 4) is a check valve comprising a spring 13 and a ball 14 which seals on a surface 15 which in operation prevents flow from the conduit 9 past it in the direction of the pump chamber 12 or the reservoir 2. In its state shown in FIG. 1 the cartridge is ready to be filled. The piston 6 has, integrally formed with it, an elongate finger 16 which maintains the ball 7 and ball 14 of the check valves in a position spaced from the surfaces on which they seal, thereby disabling the check valves to allow for filling of the reservoir 2 via the conduit 9, the elongate finger 16 being dimensioned such that its cross section does not close passageway 4 thereby allowing filling of the cartridge therethrough.

Referring now to FIGS. 3 to 5 the filling procedure will be explained in more detail. As shown in FIG. 2, with the check valves held in their disabled positions the flowable product is pumped from the filling machine outlet 11 via the flexible conduit 9. Once the reservoir has been filled with the required volume of product the plunger 6 is withdrawn (FIG. 3), first allowing ball 14 to seal against surface 15 and then, as it is further withdrawn allowing ball 7 to seal against surface 5. Once the plunger 6 has been withdrawn to this position it can not then be driven forward again to move the check valves to their disabled position again as spring 8 and/or ball 7 (depending on the exact dimensions and position of the sealing surface 5) will block its forward movement. During filling the cartridge 1 is placed in a receiving station on the filling machine, or in a separate filling jig associated with the filling machine such that the hooked feature of the plunger 17 engages with a drive of the receiving station operable to withdraw the plunger thereby activating the check valves as described above. The drive is preferably electrically operated, for example with a stepper motor, to withdraw the plunger the correct amount, however alternatively a pneumatic or manual drive could be used in which case preferably it is provided with stops to prevent the plunger from being withdrawn more than required. Once the check valves are activated the plunger may optionally be withdrawn further to draw product from the reservoir 2 into the pump chamber 12 such that the pump is primed and ready to dispense. Once the filling process is complete the coupling 10 is removed from the outlet of the filling machine and a check valve 18 is placed on the end forming the chamber outlet. The check valve 18 is operable by differential fluid pressure such that when pressure is applied on its upstream side that overcomes the internal biasing means holding it closed fluid can flow through it from the cartridge. When the pressure is removed, the internal biasing means closes the valve 18 and prevents the product in the conduit from dripping from the outlet. While this may not be problematic in some applications, where the dispensed volume is being accurately metered then any change in the volume of product in the conduit, by for example dripping, will affect the accuracy of the metered volume.

Referring to FIGS. 6 to 8, a second embodiment of the invention provides a fluid dosing cartridge 110 comprising a fluid reservoir 112, a delivery conduit 114, a positive displacement pump 116, and a check valve assembly 118.

The delivery conduit 114 comprises a flexible hose which is coupled at one end to the check valve assembly 118 and has an output nozzle 22 (described in more detail below) provided at its distal end.

The fluid reservoir 112 comprises a collapsible bag 112a and a spout 112b. The fluid reservoir 112 is provided within a cartridge housing 20. A nozzle socket 24 is provided on the uppermost (as shown in the drawings) surface of the cartridge housing 20. The nozzle socket 24 is of a complementary size and shape to the nozzle 22, to securely and releasably receive the nozzle 22 within the socket 24. As can be seen most clearly in FIG. 2, only the actual nozzle end 22a is fully received within the socket 24. The nozzle 22 and the socket 24 are both formed from sterilizable materials, so that a sterilized nozzle 22 can be stowed within a sterilized nozzle socket 24, in order to maintain the nozzle 22 in a sterile condition, generally prior to the cartridge 110 being used.

The nozzle socket 24 is provided at a location higher than the inlet end of the delivery conduit 114 (where it is coupled to the check valve assembly 118) in order to prevent siphoning of fluid through the delivery conduit 114 when the cartridge 110 is not in use. The location of the nozzle socket 24 is also selected to be laterally removed from the inlet end of the delivery conduit 114, in order to ensure that the delivery conduit 114 curves but does not crease when it is bent to locate the nozzle 22 in the nozzle socket 24.

The positive displacement pump 16 comprises a pump chamber 42 and a plunger 44. The wall of the pump chamber 42 is flexible relative to the plunger 44, which is rigid. As shown in FIG. 4, the plunger 44 comprises a plunger head 44a and a body 44b. The plunger head 44a seals with the internal surface of the pump chamber 42. To ensure that the seal is maintained, the plunger head 44a deflects the pump chamber wall, causing the pump chamber 42 to expand slightly outwards around the plunger head 44a as the plunger 44 moves through the pump chamber 42. The plunger 44 further comprises a nose 44c for engagement with the check valve assembly 19, as will be described in more detail below.

As shown in FIG. 8, the check valve assembly 118 comprises a valve housing 26 and first and second check valves 28, 30. The valve housing 26 defines a valve chamber 32, a first valve port 34, a second valve port 36, and a third valve port 38. The first valve port 34 is coupled to the spout 112b of the fluid reservoir 112 via a conduit 40. The second valve port 36 is coupled to the output of the pump chamber 42. The third valve port 38 is coupled to the delivery conduit 114.

The first check valve 28 is provided generally within the first valve port 34, and serves to open and close the first valve port 34. The second check valve 30 is provided generally within the third valve port 38, and serves to open and close the third valve port 38.

Each check valve 28, 30 comprises a resiliently biased closure member 46 and a valve seat 48, as shown in FIGS. 10 and 11 the valve seat 48 in use being assembled into a valve body. The resiliently biased closure member takes the form of a 3 mm diameter high grade stainless steel ball 46 resiliently biased under the action of a spring 50. The stainless steel ball 46 is manufactured with an extremely tight tolerance on its roundness and surface smoothness.

The spring 50 exerts a biasing force of less than 1 Newton metre on the stainless steel ball 46, such that the biasing force can be overcome by the creation of a vacuum or a fluid flow by appropriate movement of the plunger 44 within the pump chamber 42 without reducing the pressure of the liquid below its vapour pressure thereby preventing cavitation within the liquid, as will be described in detail below.

The valve seat 48 comprises a body member 52 and a circular wall member 56 which extends downwardly (as orientated in FIG. 10) from the top of the body member 52. The body member 52 and the wall member 56 together define a valve aperture 54, and the wall member 56 encloses the valve aperture 54. The wall member 56 comprises at circular cylindrical section 56a at its distal end, a central part frusto-conical sealing section 56b, and a joint section 56c where the wall member 56 joins the body member 52. The internal surface of the sealing section 56b forms the sealing surface of the valve seat 48. The sealing surface 56a is also manufactured to a high tolerance on its roundness and surface smoothness.

The included angle of the part frusto-conical sealing section 56b is sufficiently acute that the ball 46 is guided into sealing contact with the internal surface of the wall member 56, but is not sufficiently acute that the ball 46 will become wedged within the valve seat 48. In this example the included angle of the sealing section 56b is 40 degrees.

The valve seat 48 is formed from an ethylene based octane polymer material, which in this example comprises EXACT 8210 Octene-1 Plastomer produced by DexPlastomers. Forming the valve seat 48 from this polymer material gives the valve seat 48 a degree of material compliance, such that at least the sealing section 56b of the circular wall member 56 deforms under contact with the resiliently biased stainless steel ball 46, to thereby improve the seal closure between the valve seat 48 and the stainless steel ball 46.

The compliance of the wall member 56 provides the advantage that any mismatch between the roundness and surface finish of the stainless steel ball 46 and the sealing surface of the sealing section 56b can be accommodated for, thereby ensuring that an effective seal will be formed between the stainless steel ball 46 and the sealing section 56b.

One or more sections of the sealing section 56b may be made thinner than the rest of the sealing section 56b, to thereby provide additional mechanical compliance of the wall member 56 on contact with the stainless steel ball 46.

Referring to FIGS. 12 and 13, in use the check valve assembly 118 operates as follows. As the plunger 44 is drawn out of the pump chamber 42 (in the direction of arrow A), a vacuum is created in the valve chamber 32 which causes the stainless steel ball 46 of the first check valve 28 to be drawn downwards (as shown in the drawings), overcoming the action of the biasing spring 50, away from the valve seat 48, thereby opening the first valve port 34. A fluid path is thereby created from the fluid reservoir 112, via the connecting conduit 40, first valve port 34, valve chamber 32, and second valve port 36, to the pump chamber 42. Continuing movement of the plunger 44 causes fluid to be drawn out of the fluid reservoir 112, along the fluid path and into the pump chamber 42, as indicated by arrow B in FIG. 12.

Once the pump chamber 42 has been filled with fluid, the plunger 44 is pushed back through the pump chamber 42, as indicated by arrow C in FIG. 13, forcing fluid out of the pump chamber 42 into the valve chamber 32. The resulting fluid pressure replaces the vacuum and the biasing spring 50 of the first check valve 28 therefore biases the stainless steel ball 46 back against the valve seat 48 of the first check valve 28, thereby closing the first valve port 34. The fluid pressure acts on the stainless steel ball 58 of the second check valve 30 and pushes it away from the valve seat 60, overcoming the biasing force of the spring 62, and thereby opening the third valve port 38. Continuing movement of the plunger 44 towards the check valve assembly 118 forces fluid through the second check valve 30 and out through the delivery conduit 114, as indicated by arrow D in FIG. 13.

Referring to FIG. 14, the plunger nose 44c is provided for opening the check valve assembly 118 in order to allow fluid to be delivered into the fluid reservoir 112 through the third valve port 38, valve chamber 32, first valve port 34 and connecting conduit 40. The plunger nose 44c has a smaller cross-sectional size and a complementary cross-sectional shape to the valve aperture 54 in the second check valve 30, to enable the plunger nose 44c to be located through the valve aperture 54. In use, the steel ball 46 of the first check valve 28 is pushed away from its valve seat 48 by means of a tool (not shown) inserted through the connecting conduit 40; this is done prior to the fluid reservoir 112 being coupled to the connecting conduit 40 and with the cartridge housing 20 removed. The plunger 44 is then pushed towards the check valve assembly 118 such that the nose 44c enters the valve chamber 32 and traps the steel ball 46 underneath it, as shown in FIG. 14.

When the plunger 44 is fully received within the pump chamber 42, such that the plunger head 44a is located adjacent the second valve port 36, the plunger nose 44c extends through the second valve port 36, the valve chamber 32 and the valve aperture 54 of the second check valve 30, to thereby push the stainless steel ball 58 of the second check valve 30 away from the valve seat 60. The second check valve 30 is thereby opened to allow fluid to flow into the check valve assembly 118 and the fluid reservoir 112. Once the fluid reservoir 112 has been filled the plunger 42 is pulled back, releasing the stainless steel balls 46, 58 and allowing the first and second check valves 28, 30 to close.

The output nozzle 22, shown in FIG. 15, is provided with a third check valve 64 of the same type as the first and second check valves 28, 30, and comprises a valve seat 66, stainless steel ball 68, and spring 70. The third check valve 64 is provided between the delivery conduit 114 and the fluid outlet 72 of the nozzle 22. Fluid pushed out of the check valve assembly 118 by the plunger 42 and through the delivery conduit 114 reaches the third check valve 64 in the nozzle 22. The fluid pressure acts on the third check valve 64 in the same manner as on the second check valve 30, causing the third check valve 64 to open and allowing fluid to be dispensed out of the fluid outlet 72. It will be appreciated that the nozzle 22 can be either a jet-flow nozzle or a manifold nozzle.

In addition to preventing leakage of fluid out of the cartridge 110, the three check valves 28, 30, 64 within the cartridge 110 also prevent back-flow of other fluids, including air, into the cartridge 110, and in particular into the fluid reservoir 112.

Referring to FIGS. 16 to 19, a third embodiment of the invention provides a fluid dosing cartridge 200 comprising a fluid reservoir 202, a delivery conduit 204, a positive displacement pump 206, a check valve assembly 208 and a cartridge housing 210.

The fluid reservoir 202 is received within the cartridge housing 210 and comprises a collapsible bag 212 having a polypropylene spout 214 provided at one end 212a. The collapsible bag 212 comprises a three-layer laminated bag having an outer layer of polyethylene to provide structural strength to the bag 212, a middle layer of aluminum to prevent evaporation of the fluid within the bag 212, and an inner layer of polypropylene, for welding to the spout 214. The collapsible bag 212 can hold a 100 ml volume of fluid.

The spout 214 is coupled to the check valve assembly 208 via a connecting conduit 216 which extends upwardly from the check valve assembly 208, as shown in FIG. 18.

A first part of a threaded mechanical coupler is provided on the outlet section 214a of the spout 214 and the second part of a threaded mechanical coupler is provided on the distal end of the connecting conduit 216. The threaded mechanical coupler is a twin start threaded connection having a quarter turn thread. The thread is orientated such that the spout 214 is turned counter-clockwise (as orientated in FIGS. 16 and 17) to attach it to the connecting conduit 216, closing the threaded mechanical coupler.

As shown in FIGS. 16 and 17, the longitudinal axis of the spout 214 is rotationally offset from the longitudinal axis of the cartridge housing 210, by an angle of approximately 10-30 degrees in the counter-clockwise direction (as orientated in the Figures). This rotational offset of the spout 214 causes the bag 212 to adopt a longitudinally curved shape as it is collapsed, as shown in FIG. 17.

As shown in FIG. 19, when the bag 212 collapses from its full condition (FIG. 19a) to its collapsed condition (FIG. 19b) its length increases. By forcing the bag to adopt a curved shape as it collapses, the full collapsed length of the bag 212 can be accommodated within the cartridge housing 210 without the bag folding and creating occluded areas in which fluid is trapped. The bag 212 can therefore be fully emptied. The adoption of the curved shape as the bag empties ensures that the minimum sized cartridge can be used for a given volume and still empty fully and reliably every time. This is especially important where for example cartridges are being manufactured in one location, for example the Far East and then being filled and used in a remote location, for example Europe, as the minimisation of space envelope to contain the same volume of liquid plays an important economical role in the shipping of large volumes of empty containers.

In addition to emptying reliably the curved shape of the empty bag in the cartridge also assists the reliable filling of the cartridge without causing creases in the bag material which may harm the integrity of, for example the aluminum layer in the bag.

Since the threaded mechanical coupler is closed by turning it in the counter-clockwise direction, any additional torque applied to the threaded mechanical coupler as a result of the bag 212 collapsing into a curved shape will cause the coupler to further tighten.

The check valve assembly 208 couples the spout 214 to the positive displacement pump 206, and the positive displacement pump 206 to the delivery conduit 204. In the same manner as described above in relation to the first embodiment. The fluid dosing cartridge 100 is operated in the same general manner as the fluid dosing cartridge 210 of the first embodiment.

Various modifications may be made without departing from the scope of the present invention. In particular, in the second embodiment the following modifications may be made. The check valve assembly may be constructed with a single check valve, being the first check valve. The stainless steel balls may be of a different size to those described. The stainless steel ball valve closure members may be replaced by a part-spherical closure member, or may be fabricated from a different material. The valve seat may be fabricated from a different ethylene based octene polymer material to that described. The wall member of the valve seat may alternatively be of a larger circumference than the valve aperture. The body member of the valve seat, and in particular the external part-conical shaped wall, may be of a different size and shape to that shown. The wall member may have a different profile or thickness variation to that described in order to give the wall member a degree of mechanical compliance. The wall member may alternatively not have a varying thickness, the material compliance of the wall member providing sufficient compliance to the valve seat. The resilient member may take a different form to the spring described, and may exert a different biasing force to that described. The plunger may be of a different configuration to that described and, in particular, may not have a nose section. It will also be appreciated that the fluid dosing cartridge of the second embodiment may be provided without the nozzle and nozzle socket arrangement, and that the nozzle and nozzle socket arrangement may be provided on a fluid dosing cartridge having a different check valve assembly to that described in connection with the second embodiment.

In the third embodiment, the spout may be rotationally offset by a different angle to that shown in the Figures, and may alternatively be offset in the clockwise direction, the bag thereby being caused to adopt a curved shape having the opposite sense to that shown. The spout may be located towards the bottom of the bag, to help avoid any fluid being trapped within the bag as it is emptied. Different mechanical coupling means may be use to connect the spout to the connecting conduit.

It will be appreciated that the features of any two or more of the above described embodiments may be combined in a single fluid dosing cartridge. For example, the cartridge of the first embodiment may additionally have the features of the output nozzle and the nozzle socket of the second embodiment and/or the rotationally offset spout of the third embodiment. Similarly, the cartridge of the second embodiment may additionally have the feature of the rotationally offset spout of the third embodiment, and the cartridge of the third embodiment may be provided with the output nozzle and nozzle socket of the second embodiment.

The second embodiment provides various advantages, as follows. The provision of a nozzle socket of a sterilizable material on the cartridge housing enables a sterilized nozzle to be stored within a sterilized environment, to thereby maintain the nozzle in a sterilized condition, generally prior to initial use of the cartridge. The location of the nozzle socket above and laterally displaced from the inlet end of the delivery conduit ensures that the delivery conduit curves but does not crease when it is bent to locate the nozzle in the nozzle socket, and also prevents siphoning of fluid through the delivery conduit when the cartridge is not in use.

Forming the valve seat from the ethylene based octene polymer material gives the valve seat a degree of material compliance, enabling the circular wall member to deform under contact with the resiliently biased stainless steel ball, to thereby improve the seal closure between the valve seat and the stainless steel ball and to absorb and mechanical imperfections in the surface of the ball or the sealing surface of the wall member. In addition, using an ethylene based octane polymer material enables the cartridge to be used to dose fluids containing short chain hydrocarbons which would be absorbed by elastomer materials, causing the valve seat to change size and/or shape.

Making some sections of the wall member thinner, by angling the upper section of the wall member to give it varying thickness, additionally gives the valve seat a degree of mechanical compliance under contact with the resiliently biased stainless steel ball, thereby further improving the seal closure between it and the ball. The resulting tight seals formed by the check valves prevent leakage of fluid from the cartridge and also prevent back-flow of other fluids, including air, into the cartridge.

From another aspect of the present invention there is provided a method of filling a disposable dispensing cartridge with a flowable product comprising the steps of assembling the cartridge with a pump of the piston-in-chamber type, the piston carrying means that hold first and second check valves, associated with an inlet and an outlet of a piston chamber respectively, in an open position when the piston is in its forward position, presenting the cartridge outlet to a filling means, pumping a flowable product from the filling means into a reservoir within the cartridge via the open check valves and, once the reservoir is full, withdrawing the piston into the piston chamber sufficiently that the check valves are released to assume their working position preventing flow from the outlet into the pump chamber and from the pump chamber into the reservoir.

1-50. (canceled)

51. A disposable dispensing cartridge for a flowable product comprising a reservoir for storing the product, a pump means having a pump chamber and operative to withdraw said product from the reservoir into the pump chamber and to expel liquid from the chamber; a first passageway interconnecting the reservoir and the pump chamber; a second passageway interconnecting the pump chamber and an outlet from the chamber; and valve means operable, in use, by differential fluid pressure, to open the first passageway and close the second passageway during a liquid withdrawal step, and to close the first passageway and open the second passageway during the expelling step, and wherein the cartridge further comprises a means to maintain the valve means in a position in which both passageways are simultaneously open and interconnected thereby enabling the reservoir to be filled via the outlet.

52. A disposable dispensing cartridge according to claim 51, wherein the valve means comprises a first valve means associated with the first passageway and a second, separate, valve means associated with the second passageway.

53. A disposable dispensing cartridge according to claim 52, wherein the valve means comprise first and second check valves and the cartridge comprises a means to hold the check valves open allowing back flow past them enabling the reservoir to be filled.

54. A disposable dispensing cartridge according to claim 53, wherein once the cartridge is filled the check valves can assume a normal working position.

55. A disposable dispensing cartridge according to claim 54, wherein once the check valves have assumed their normal working position, the means for holding them open can not be re-employed.

56. A disposable dispensing cartridge according to claim 53, wherein the pump is a piston pump comprising a piston in the pump chamber.

57. A disposable dispensing cartridge according to claim 56, wherein the piston carries said means that holds the check valves open.

58. A disposable dispensing cartridge according to claim 57, wherein the said means carried by the piston is a thin finger-like extension protruding from it.

59. A disposable dispensing cartridge according to claim 57, wherein each of the check valves comprises a spring loaded closure element closing against a valve seat.

60. A disposable dispensing cartridge according to claim 59, wherein said means carried by the piston displaces the closure elements away from their respective valve seats thereby maintaining them open.

61. A disposable dispensing cartridge according to claim 60, wherein the said means carried by the piston displaces the closure element of one check valve along the axis of the pistons travel within the pump chamber.

62. A disposable dispensing cartridge according to claim 61, wherein the said one check valve is the second check valve.

63. A disposable dispensing cartridge according to claim 57, wherein the said means carried by the piston holds one of the check valves in its open position by projecting laterally between the closure element and its valve seat.

64. A disposable dispensing cartridge according to claim 63, wherein the said one check valve is the outlet check valve.

65. A disposable dispensing cartridge according to claim 57, wherein the check valves are substantially at 90 degrees to one another.

66. A disposable dispensing cartridge according to claim 57, further comprising the outlet comprises a flexible conduit coupled at one end to the second check valve.

67. A disposable dispensing cartridge according to claim 66, further comprising a third check valve at the other end of the flexible conduit.

68. A disposable dispensing cartridge according to claim 51, further comprising electronic data storage means capable of storing data pertaining to the flowable product within the cartridge.

69. A method of filling a disposable dispensing cartridge with a flowable product comprising the steps of: assembling a disposable dispensing cartridge comprising a reservoir for storing the product, a pump having a pump chamber, a first check valve between the reservoir and the pump, a second check valve between the pump and an outlet of the cartridge, the arrangement being such that the first and second check valves are held in an open position allowing backflow past them; presenting the cartridge outlet to a filling means, pumping a flowable product from the filling means into the reservoir via the outlet and the open check valves; and, once the reservoir is full, allowing the check valves to assume a normal working position preventing flow in the direction from the outlet to the reservoir.

70. A method of filling a disposable dispensing cartridge according to claim 69, wherein after presenting the cartridge outlet to a filling means and prior to pumping the flowable product from the filling means into the reservoir, a partial vacuum is applied to the reservoir to at least partially evacuate it.

71. The method according to claim 69, further comprising the step of separating the outlet from the filling means once the reservoir has been filled, and attaching a third check valve to the outlet.

72. The method according to claim 69, further comprising the step of, once the reservoir is full, filling the pump chamber thereby priming the pump.

73. A method of filling a disposable dispensing cartridge with a flowable product comprising the steps of assembling a disposable dispensing cartridge providing a reservoir within the cartridge for the product with a pump having a pump chamber and a piston, the piston carrying means that hold first and second check valves, associated with an inlet and an outlet of the pump chamber respectively, in an open position when the piston is in its forward position, presenting the outlet to a filling means, pumping a flowable product from the filling means into the reservoir within the cartridge via the open check valves and, once the reservoir is full, withdrawing the piston into the pump chamber sufficiently that the check valves are released to assume a working position preventing flow from the outlet into the pump chamber and from the pump chamber into the reservoir.

74. A method of filling a disposable dispensing cartridge according to claim 73, wherein after presenting the cartridge outlet to a filling means and prior to pumping the flowable product from the filling means into the reservoir, a partial vacuum is applied to the reservoir to at least partially evacuate it.

75. The method according to claim 73, further comprising the step of, once the reservoir is full withdrawing the piston in the pump chamber to fill the pump chamber thereby priming the pump.
